(19) United States
(12) Patent Application Publication
(10) Pub. No.: US 2026/0091322 A1
(43) Pub. Date: Apr. 2, 2026

(54) DEVICE WITH INTERNAL PROJECTION AND ITEM

(71) Applicant: MINDSCOPE PRODUCTS, GLENDALE, CA (US)

(72) Inventor: GEORGE BALANCHI, GLENDALE, CA (US)

(21) Appl. No.: 19/410,909

(22) Filed: Dec. 5, 2025

Related U.S. Application Data
(63) Continuation-in-part of application No. 18/210,414, filed on Jun. 15, 2023.
(60) Provisional application No. 63/782,254, filed on Apr. 2, 2025.

(51) Int. Cl. A63H 13/02; A63H 33/26; G03B 21/14; G03B 29/00

(52) U.S. Cl. CPC A63H 13/02; A63H 33/26; G03B 21/145; G03B 29/00; A63H 2200/00

(57) ABSTRACT

A device including an exterior wall, wherein the entirety of the exterior wall defines a decorative shape of the device and further defines an interior surface and an exterior surface; a projector, supported by the projector support within the cavity and contained entirely within the device, the projector configured to project an image or animation of something inside the exterior wall, when viewed from the exterior of the device; and a decorative item or toy disposed inside the exterior wall. In some embodiments the device may further include an audio output device configured to output an audio track and/or an opening or unlocking mechanism for opening or unlocking at least a portion of the housing where decorative item or toy may be disposed.

### RELATED APPLICATIONS

The present application is a continuation-in-part of, and claims priority to U.S. patent application Ser. No. 18/210,414 filed on 15 Jun. 2023 entitled “Animated Decorative Items with Sensor Inputs,” which is incorporated by reference herein in its entirety. The present application also claims priority to U.S. Provisional Patent Application No. 63/782,254 filed on 2 Apr. 2025, entitled “Device with Internal Projection and Item,” which is incorporated hereby reference in its entirety.

### BACKGROUND

Interactive toys have long captivated the interest of children and adults alike, offering entertainment while fostering curiosity and imagination. One category of interactive toys involves simulating natural phenomena, such as the growth and hatching of an egg. These toys aim to provide engaging, educational experiences that mirror biological processes, sparking fascination and offering opportunities for learning through play.

Traditional hatching egg toys typically rely on mechanical features or simple timers to simulate the hatching process. While effective in delivering visual appeal, these conventional designs often lack the depth of interactivity or realism that modern consumers desire. With advancements in technology, there is an increasing demand for toys that incorporate multimedia capabilities to enhance the user experience, creating more immersive and meaningful connections.

The present invention seeks to elevate the concept of a hatching egg toy by introducing an innovative design with advanced functionality. The toy is shaped like an egg and includes an internal projector that visually represents the growth and development of the entity inside the egg over time. The projector displays dynamic images, animations, or other visual elements to simulate the biological stages of development, fostering anticipation and engagement. After a predetermined time period or upon receiving an external input, the toy undergoes a mechanical or electronic transformation to “hatch,” revealing its contents to the user.

This invention addresses key limitations of existing hatching egg toys by integrating sophisticated technology to enhance realism and interactivity. The internal projector not only entertains but also provides an educational element, making the toy ideal for children interested in science, nature, and the wonders of growth and development. Furthermore, the toy's ability to “hatch” in response to user input encourages active engagement, promoting emotional investment and rewarding curiosity.

The combination of a realistic egg-shaped design, multimedia growth simulation, and hatching functionality represents a significant advancement in interactive toys. By blending play and education in a compelling format, this invention offers users an unforgettable experience that is both entertaining and enriching.

### SUMMARY OF THE INVENTION

In accordance with some embodiments of the present invention, aspects may include a device comprising: a housing, the housing enclosing: a projector; a decorative item or toy.

In accordance with some embodiments of the present invention, aspects may include a device, comprising: an exterior wall, wherein the entirety of the exterior wall defines a decorative shape of the device and further defines an interior surface and an exterior surface; a projector, supported by the projector support within the cavity and contained entirely within the device, the projector configured to project a image or animation of something inside the exterior wall, when viewed from the exterior of the device; and a decorative item or toy disposed inside the exterior wall.

In accordance with some embodiments of the present invention, aspects may include a housing comprising an interior surface and an exterior surface, and wherein at least a portion of the exterior surface has a thickness and material composition selected such that, in response to projection of an image or animation onto a portion of the interior surface, the image or animation is visible on the exterior surface.

In accordance with some embodiments of the present invention, aspects may include an audio output device configured to output an audio track, wherein the projected image or animation is projected in synchronization with the audio track.

In accordance with some embodiments of the present invention, aspects may include at least one sensor configured to detect at least one condition of the device or an environment of the device. The at least one sensor comprising one or more of a proximity sensor, timer, accelerometer, light sensor, temperature sensor, pressure sensor, motion sensor, sound sensor, spring sensor, ball sensor, and/or angular velocity sensor. The at least one sensor may be operatively connectable to the projector to activate, deactivate, and/or modify display of the animated image and/or any associated audio in response to detection of the condition. In some embodiments, the at least one sensor may be operatively connectable to an opening or unlocking mechanism for opening or unlocking at least a portion of the housing.

In accordance with some embodiments of the present invention, the housing may be in the shape of an egg, cave, or other enclosure; and the projected image or animation comprises a representation of a creature inside of the egg, cave, or other enclosure.

In accordance with some embodiments of the present invention, the device may further comprise: an exterior wall, wherein the entirety of the exterior wall defines a decorative shape of the device and further defines an interior surface and an exterior surface; a projector, supported by the projector support within the cavity and contained entirely within the device, the projector configured to project a image or animation of something inside the exterior wall, when viewed from the exterior of the device; and a decorative item or toy disposed inside the exterior wall.

These and other aspects will become apparent from the following description of the invention taken in conjunction with the following drawings, although variations and modifications may be affected without departing from the scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary device with an internal projector and item, in accordance with some embodiments of the present invention.

FIG. 2 illustrates an exemplary device with an internal projector and item, in accordance with some embodiments of the present invention.

FIG. 3 illustrates an exemplary device with an opening mechanism, in accordance with some embodiments of the present invention.

FIG. 4 depicts an exemplary device with an opening mechanism, in accordance with some embodiments of the present invention.

FIG. 5 illustrates an exemplary graphic representation of a device with an internal projector and opening mechanism, in accordance with some embodiments of the present invention.

FIG. 6 sets forth an exemplary flow of a device with an internal projector and opening mechanism, in accordance with some embodiments of the present invention.

FIG. 7 illustrates exemplary exterior vessel designs, in accordance with some embodiments of the present invention.

FIG. 8 illustrates an exemplary exterior vessel, with cracks or lines of separation, in accordance with some embodiments of the present invention.

FIG. 9 illustrates an exemplary vessel with a top portion removed, in accordance with some embodiments of the present invention.

FIG. 10 illustrates an exemplary vessel with various components removed, in accordance with some embodiments of the present invention.

FIG. 11 illustrates an exemplary vessel with various components removed, in accordance with some embodiments of the present invention.

FIG. 12 illustrates some of the inner workings of an item with a projector in accordance with some embodiments of the present invention.

FIG. 13 illustrates a back view of an exemplary item, showing exemplary controls, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

As discussed above, in accordance with some embodiments of the present invention, a device may be provided that may encapsulate a toy. In addition, the device may encapsulate a projector, which may project upon a surface of the device a picture or animation that may be related to the toy inside. For example, a projector may show a dinosaur growing inside an egg. After a specified amount of time or upon the receipt of a particular input, the device may unlock or physically open, and a toy-such as a baby dinosaur-within the device may be presented and/or accessible to a user.

In accordance with some embodiments, the device may comprise one or more sensors, and pictures, animations, and/or sounds played by the device may be triggered or initiated by, or related to a sensor input. For example, inputs from a sound sensor and a motion sensor (such as but limited to an accelerometer) may indicate that the device is being handled by a user. At such time, a projector may display an animation of a baby animal moving around inside the egg, perhaps with accompanying sound or music. In some embodiments, a light sensor may indicate daytime, and a morning or wake-up animation may play—for example of a creature or animal inside the device stretching or yawning.

In accordance with some embodiments of the present invention, the device may take the shape of an egg, and creatures displayed to be inside (and potentially inside the egg in the form of a stuffed animal, toy, etc.). Creatures inside the “egg” may include, but are not limited to: chickens, ducks, other birds or fowl, platypuses, turtles, snakes, lizards, frogs, toads, dinosaurs, etc. In accordance with some embodiments of the present invention, the device may take the shape of a rocky outcropping, with the inside cavity configured or presented as a cave. The creature inside may then, for example, be a bear, bat, spider, insect, groundhog, etc. In some embodiments, the device may be configured as a den within the ground or dirt. Corresponding creatures may then be prairie dogs, meercats, rabbits, skunks, etc.

In accordance with some embodiments of the present invention, the device may be configured as any other material or thing, such as a dam for a beaver, a nest for birds, a hollow-tree for raccoons or porcupines, opossums, squirrels or chipmunks, etc. It is contemplated that various animals and various habitats may be presented. Even so far as the device may be configured as an aquarium or vessel filled with water, and the creature inside may be a fish, dolphin, shark, whale, otter, seal, ray, octopus, and/or any other type of marine animal or creature. In accordance with some embodiments of the present invention, the device may be configured as any sort of container or vessel, for example such as a box or crate.

The present application is generally directed to various embodiments that may utilize one or more sensors in order to create a more interactive, communicative, and/or enjoyable experience.

For example, as noted above, a device may include a voice activated sensor. A user may say specific words and/or lines to initiate or trigger the device to say something or act in a specific or random manner. For example, a user may say “Hey Baby Dino, tell me a joke,” after which the device may select a random joke from a library of prerecorded jokes. Additional commands could be “sing me a song,” “tell me a story,” or even responses to general questions “what's your favorite color” or “what's your favorite food.” In accordance with some embodiments, the device may be configured to sing with a user, for example by singing a well-known verse or chorus, or singing half of a duet.

In accordance with some embodiments of the invention, two or more devices may interact with each other through such audio sensors. For example, a user may ask a first device to “tell me a joke,” and after a joke is told, a second device may say something along the lines of “that's not funny. My joke is funny . . . ” and proceed to tell a second or third joke. In this manner the devices may interact not just with the user, but with each other. Entertaining arguments, songs, stories, etc. may be told by more than one device. Note that there are various ways that devices may be configured for such interactivity. For example, there may be a selector (physical, digital, or virtual (e.g., via an application)) that may place an device in a stand-alone state, interactive state, responsive only state, etc. In this manner, a user may control the trigger of interactivity, rather than be barraged by a cacophony of singing/joking/talking devices.

In accordance with some embodiments, a device may include one or more motion or light sensors (for example, but not limited to, an infrared sensor). When the sensor detects motion or movement, the device may play a statement and corresponding animation. For example, a device in the shape of a dinosaur egg may say “I'm still sleeping . . . come back later!” or something of the like.

Note that it is contemplated to have inter-operative capabilities between various sensors. For example, device A may detect motion (via a motion sensor) and play a statement. Device B may hear the statement (via a sound sensor) and respond, and so on. In accordance with some embodiments, multiple devices may play off of each other, joke back-and-forth, hold conversations, sing songs, etc. as a group.

In accordance with some embodiments, a device may be configured with one or more touch sensors disposed on various portions of the device itself. Touch sensors may be placed through a device, such that the device may generate a statement or joke depending on the portion of the device pressed or touched by a user.

It is also contemplated that a device may include a sensor that determines if various accessories are present. For example, a device in the shape of a chicken egg may be equipped with a “nest”. When the device is removed from the nest, the device may detect its removal and state “put me back in my nest!”

It is also contemplated that a device may interact with a remote sensor. Remote sensor may be wireless or may be wired to the device. When a user trips the remote sensor (for example, via motion), the device may begin to play statements, songs, jokes, motions, animations, etc.

In some embodiments, the device may also be equipped with a movement or acceleration sensor, which may indicate that the device is being picked up or moved. When such inputs are received the device may play a subset of statements-such as “put me down!”, “where are we going”, “are we running away together”, “oh wait, I forgot something”, “let's roll!”, etc. Similarly, in the case of a crash or impact, the device may utter “Ouch, that hurt!”, “that's going to leave a mark!” or the like.

It is also contemplated that various devices may be configured to access various libraries of statements, songs, jokes, etc. This may be useful for multiple reasons. For example, during the holiday season a snowman may be configured to draw statements, jokes, songs, etc. from a data base of Christmas devices, or a database of Channukah devices. In a different variation, a device in the home of a family with young children may draw upon younger jokes or more accessible statements, while a device in a predominantly adult household may be configured for more adult content, for example more risqué jokes or innuendos.

In accordance with some embodiments of the present invention, the device may comprise an equalizer chip or other similar functionality, which may enable a user to speak into a remote microphone (or smartphone, through the use of a corresponding application), and have the decorative device “say” what is being spoken. Various movement or motion of the device, facial features, etc. may accompany the playback. In addition to repeating real-time, near real-time, or live audio input into a remote microphone, it is also contemplated that a device may playback recorded messages or sayings. In this manner, a remote user—for example, a grandparent located geographically remote from the device—may leave a fun “message” that may be replayed through the device.

In accordance with some embodiments, a device may be equipped with remote connectivity, such as through a WiFi, Bluetooth, Near Field Communications (NFC), etc. connections. Using such remote connectivity, the device may download additional information-such as songs, sayings, jokes, even “personalities.” It is also contemplated that a user may use an application running on a smart phone to download such information and then may provide such information to the device through a second connection, which may be, for example, wired or via Bluetooth.

As noted above, a device may comprise a projector to project an animation that may make a character inside the device appear to be moving, talking, singing, or otherwise alive. In some embodiments, the animation of the facial expressions, etc. may be programmed to correspond with words being played, songs, etc. In accordance with some embodiments of the invention, the projector may play recorded, live, real-time, or near real-time via the projector onto the decorative device. In this manner, anyone with a corresponding application may record video—or provide a real-time or near real-time video feed. This video or video feed may be projected by the projector onto the “face” of the decorative device, thereby, for example, making it look like a grandparent several states away is a singing baby chicken, etc.

In accordance with some embodiments, the device may include a camera or other image input device which may receive a video and/or audio-video input. The device may, in accordance with some embodiments, be further equipped with a processor configured to categorize, recognize, and/or determine captures from the camera. For example, a camera may be located at the front of the device, and the device may determine when someone is interacting with the device. The device may be configured to recognize certain devices (such as other devices, or devices associated with a specific event or time. Such recognition or determination may be performed utilizing methods as known in the art, such as but not limited to computer vision technologies.

Cameras may also permit a device to interact with a second device, in a manner in which device 1 projects images or video captured by device 2, and vice versa. In this manner, parties separated by distance may utilize devices to communicate with each other in an entertaining and amusing manner.

As briefly mentioned above, there may also be interactivity between various decorative devices. For example, a first device may detect an input from a sensor—or even an ON/OFF switch and may determine and play a responsive sound and animation. A second device may respond to the first device, triggered by a sensor that detects the first device's sound or animation, or from a direct communication from the first device (for example, via Bluetooth, NFC, etc.). The second device may respond to the first device. A third device may also be involved in the growing “discussion” between decorative devices. Each device may communicate with each other, or may work together—for example, to sing songs together (in parts or in harmony).

According to various embodiments, a projection system is implemented as an entertainment product that provides life-like and/or interactive displays of animations. For example, it can be used to project animated images on an interior surface of a molded plastic enclosure such as a hollow plastic egg-shaped enclosure, with a singing and/or talking baby creature. The projector and/or accessories, such as a speaker and/or a storage device, may be situated within the plastic enclosure. The animated images may be updateable by the user, allowing for a wide variety of animated images, songs, and the like, which can be customized for individual users.

In at least one embodiment, the described device projects customizable animated images onto the interior surface of an enclosure in the form of a decorative plastic figure. An internal storage device (such as an SD card) and/or communications device (such as Bluetooth or Wi-Fi receiver) stores and/or receives audio and/or images, such as static and/or animated images. Animated images can be received from a computing device such as a smartphone or other device, and/or from the Internet. In at least one embodiment, a user can purchase and/or download animated images via a computer or smartphone, for playback on the device.

A projector may display an animated image. In at least one embodiment, the device inside the enclosure can connect with and communicate with other devices, such as a computing device such as a smartphone, via wired or wireless communication. In this way, the device can be made to play static images, animated images, music, and/or audio as directed by the consumer operating the computing device. In at least one embodiment, a remote control can be provided, to allow a user to select among a number of different images, and/or to control the device in other ways (e.g. to change volume, download additional images, power on/off, and/or the like). Alternatively, such control can be provided via an app running on the computing device.

In accordance with some embodiments, the device may be self-contained; the projector and other components are situated inside the enclosure so that no external projector is required. A power supply (such as a battery) may be included within the enclosure; alternatively, a power cord may be provided that allows the device to be powered from an external source.

In at least one embodiment, a custom lens is employed to enable the short-throw projection of images onto the interior surface. In at least one embodiment, the interior surface may be concave and/or irregular, for example if the enclosure represents an egg. In at least one embodiment, 3D-printed shape-specific lenses and/or mirrors can be used, to enable image focus on an uneven interior surface of the enclosure.

In at least one embodiment, the enclosure may be made of plastic that allows infrared (“IR”) signals to pass through the device so that a remote control and/or one or more other wirelessly-connected devices can be used to change the images. Vents can be provided on the enclosure to enable sound to emanate from the device.

In various embodiments, the enclosure can be molded into any of a number of unique shapes (such as pumpkin, snowman, face, jewelry mannequin, and the like). Corresponding images for such themed enclosures can be offered.

In at least one embodiment, the system can also include a sensor that detects motion, heat, and/or other conditions to enable the system to react to external events (such as a person walking by) and cause the animated image to change accordingly. In at least one embodiment, an artificial intelligence component can be included, to allow the animated image to speak or interact in real-time, with content that adapts and reacts to environmental stimuli. In yet another embodiment, the animated image can be controlled in real-time by a user.

For example, the device may stream or cast animations and audios from a user device. For example, a video from a website may be sent to the device and projected onto the device face. In addition, a song may be streamed, casted, or sent to the device, and the device may play the song while animating facial expressions as if the device was singing the song. Facial animation may comprise specifically programed phoneme shapes that correspond to specific sounds, in order to give the illusion that the device is singing.

In yet another embodiment, image and/or sound content can be user-customizable. For example, a user can use a web-based application to design greetings, songs, and/or the like, with custom components, such as names for a child's birthday.

In accordance with some embodiments of the present invention, additional features of the device may be triggered by sensor input. Touch sensors may trigger the device to say “I'm glad we're going somewhere . . . I was bored sitting there!” or the like.

In addition, in accordance with some embodiments of the present invention, devices may comprise a combination of projection and mechanically animated (i.e., animatronic) elements. For example, a character's eyes and nose may be projected, but mouth and jaw may be mechanically operated. In these circumstances, opening and closing of the jaw and mouth may be accomplished in conjunction with animation of the eyes in order to present an illusion that the device is talking.

Note that the present invention may be applicable to any number of configurations. For example, a housing may represent a womb and a projection may show growth of an infant inside, with the womb opening and/or an item internal to the housing being accessible at a specified time (for example, a due date). The item may be any number of things, from a doll to a memento, to a decorative item.

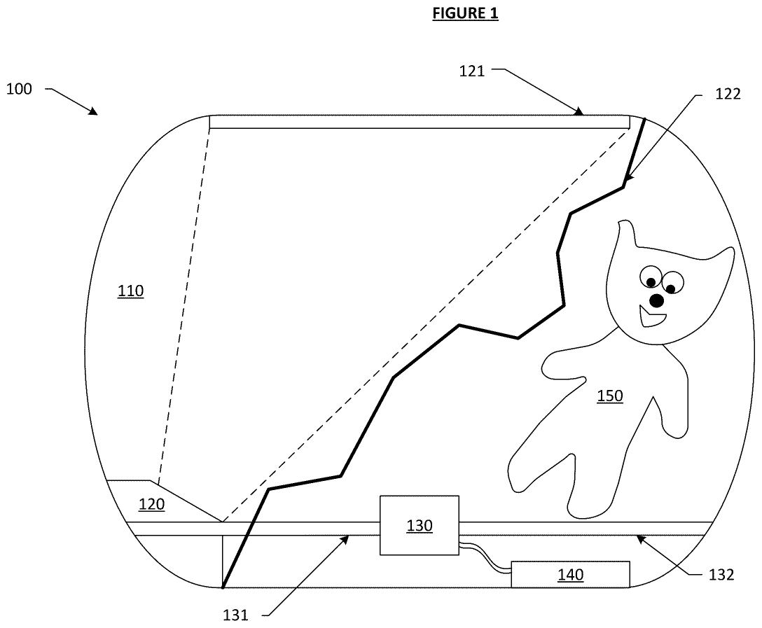

With reference to FIG. 1, a device 100 in accordance with some embodiments of the present invention will now be discussed. Device 100 may comprise a housing 110, which may—in accordance with some embodiments—be in the shape or style of an egg. Inside housing 110, a projector 120 may be disposed, such that projector 120 may project an image 121 on a surface of the housing 110. The housing 110 may be entirely or partially translucent, clear, opaque, or any other arrangement configured to allow an internal projection to be visible from the exterior. Device 100 may also comprise a mechanism 130 for opening the housing 110. For example, mechanism 130 may exert an outward force on members 131, 132, thereby opening housing 110 at crack, opening, or line of weakness 122. In accordance with some embodiments of the present invention, controller 140 may control or provide control signals to projector 120 and/or mechanism 130. In some embodiments controller 140 may also provide outputs to additional items or features, such as a speaker.

When mechanism 130 opens the egg 110, toy or item 150 may be presented or visible to a user. In some embodiments, toy or item 150 may be accessible to a user; in some embodiments the toy or item 150 may be pushed up or outwards (similar, for example, to a traditional jack-in-the-box toy).

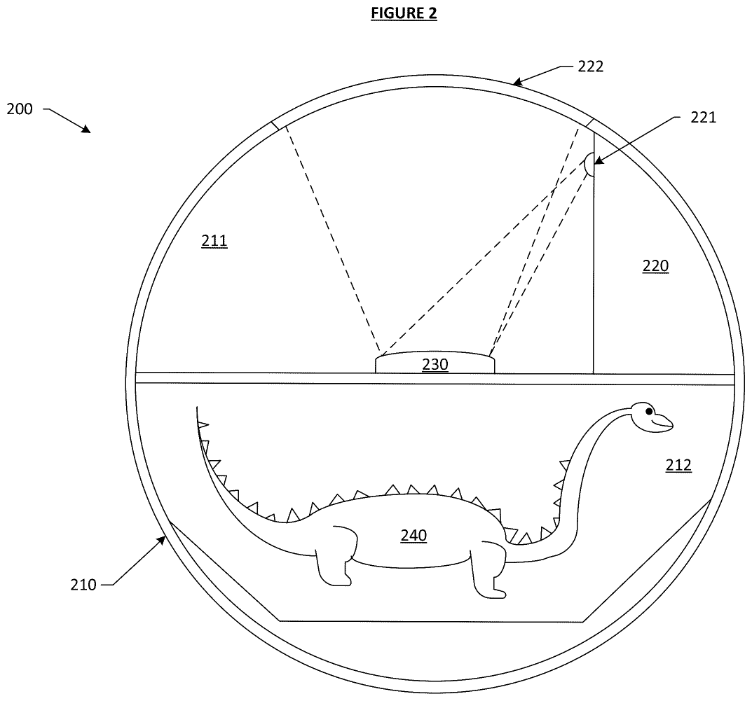

FIG. 2 illustrates another embodiment of a device 200, again comprising a housing 210, which may be split into two halves, or hemispheres 211, 212. First hemisphere 211 may comprise a projector 220, which may project an image from a lens our output 221, the projection may be reflected off a mirror 230 and projected onto a portion of the housing 222 such that the image or animation projected may be visible from outside of the housing 210. Mirror 230 may be utilized for one or more uses. For example, mirror 230 may be utilized to increase the throw length of the projection. Mirror 230 may also be used to redirect, spread, focus, and/or alter the projection in a variety of manners.

Second hemisphere 212 may comprise a storage area for a toy or item 240. This storage area may be accessible to a user at any time or may be locked or otherwise inaccessible until released by an internal mechanism.

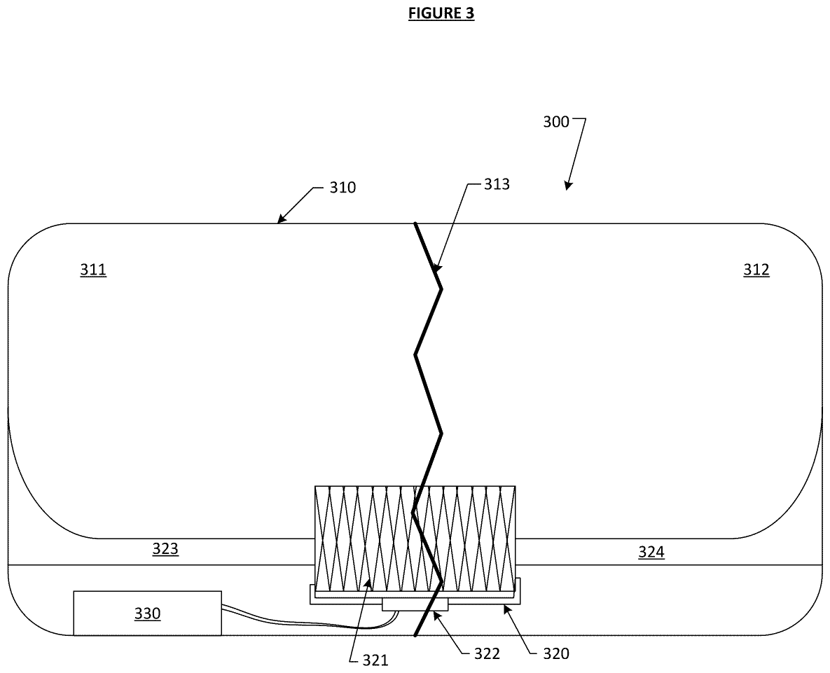

With reference to FIG. 3, an item 300 may again comprise a housing 310, that may be formed from two halves 311, 312 which may join (or separate) at joint 313. Device 310 may also comprise mechanism 320, which may, in accordance with some embodiments of the present invention, comprise a spring 321 that may be maintained in a compressed position, or example by a clamp or clip 322. Device 300 may also comprise a controller 330 which may be in communication with the mechanism 320. When the mechanism 320 releases the compresses spring 321, ends of the spring 321 may engage or exert a force on members 323, 324, thereby pushing the two halves of the housing 311, 312 apart so that an inner cavity may be accessed or accessible by a user.

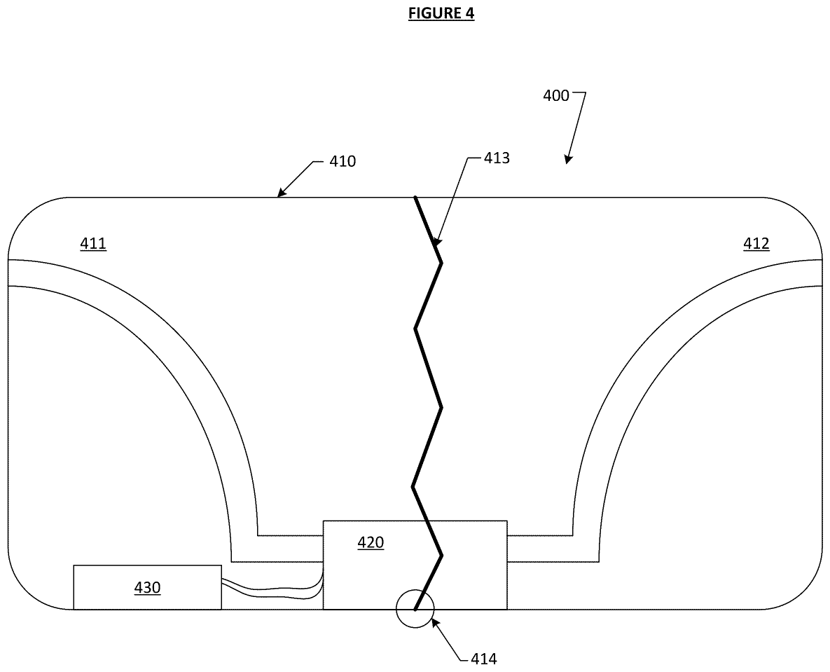

With reference to FIG. 4, an alternative method of opening a device 400, in accordance with some embodiments of the present invention will now be discussed. Device 400 may comprise a housing 410, which may be formed of two halves 411, 412, which may be separated by a crack or line 413, and joined together by a hinge or pivot 414. Device 400 may also comprise a mechanism 420, which may receive a signal or communication from control module 430, which may cause the mechanism 420 to exert a force on members 421, 422, thereby causing the housing 410 to open along crack 413, pivoting about hinge or pivot 414.

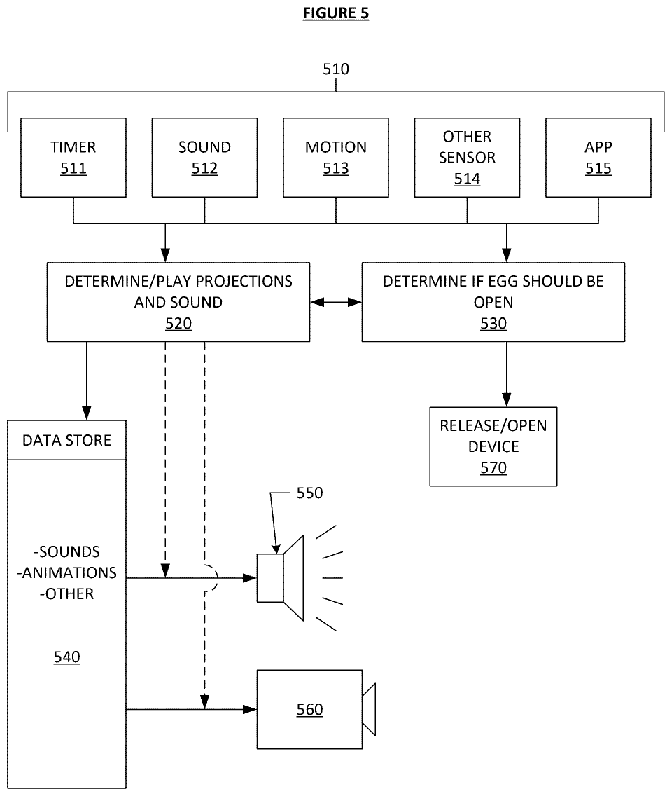

With reference to FIG. 5, a graphic representation of a device 500, in accordance with some embodiments of the present invention will now be discussed. Device 500 may comprise sensors 510, which may include any number of types of sensors, including but not limited to at least one or more of a timer 511, a sound sensor 512, a motion sensor or accelerometer 513, other sensors (light, temperature, etc.) 514, and/or interactions with an application (or “app”), which may interact with device 500, as discussed in greater detail below.

At 520, sensor input may be utilized to determine and play projections and/or sound. Access to a data store 540, which may store one or more pictures, graphics, animations, videos, sounds, songs, etc., may provide a library from which appropriate, proper, or desired projections may be drawn. In accordance with some embodiments of the present invention, such data store 540 may be configured to receive updates and/or additional information or projections. For example, it is contemplated that a user may upload pictures, graphics, or animations to the device. In some embodiments, additional or enhanced animations may be selected from application 515, and sent to, downloaded by, or accessed by the speaker 550 and projector 560 to be played. In this manner, the device may be personalized and/or contoured to a specific user or environment.

In general, projections and sounds may be triggered or initiated by inputs from one or more sensors 510. For example, if a motion sensor 513 detects motion, a projection of a sleeping creature may waking up may be played. If a particular sound is detected by sound sensor 512, a projection and an accompanying sound may be played back. In accordance with some embodiments, when a timer 511 expires (which may be based on duration, for example, thirty (30) days; or may be based on a calendar date, for example, March 15th), a specific projection and/or sound may be played, such as a creature stretching and pushing against the sides of the egg (the device), potentially accompanied by a cracking sound.

At 530 it may be determined if the egg (the device) should be opened. This may again be based on sensor 510 input, such as but not limited to timer. In accordance with some embodiments of the present invention, the device may be opened upon receiving specific inputs, such as specific words or sounds; in some embodiments, the device may open when it is determined to be in close proximity to other items, such as other “eggs” or other items.

If it is determined at 530 that the device should be opened, at 570 a mechanism to open the device may be triggered, activated, or released. In accordance with some embodiments of the present invention, the device may physically “pop” open, while in other embodiments, the device may simply be unlocked and accessible by a user.

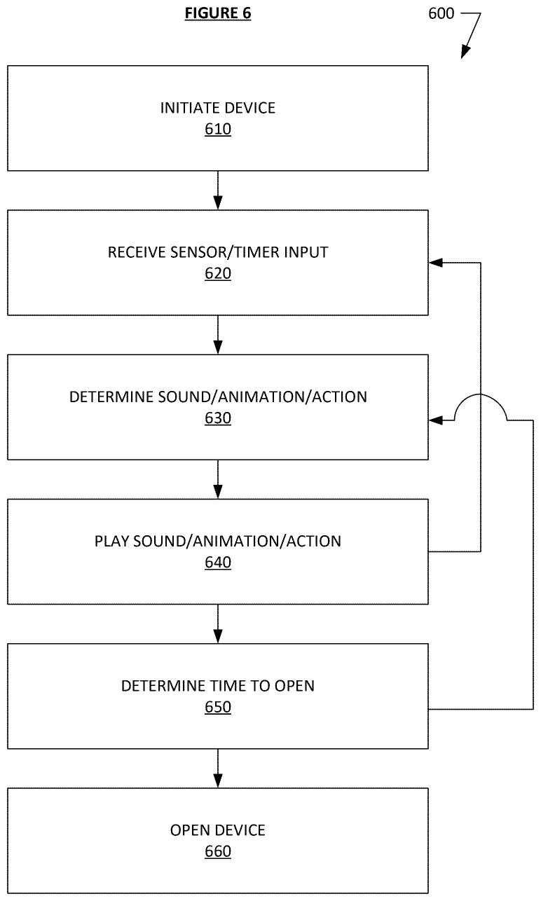

With reference to FIG. 6, an exemplary flow 600 will now be discussed. At 610 a device may be initiated. This may comprise the device being turned on, batteries being inserted, a removable tab preventing a complete electrical circuit may be removed, a switch may be selected, etc. Initiating a device may engage or turn on sensors, timers, projectors, speakers, etc.

At 620 a processor in the device may receive an input from a sensor or timer. The processor may then at 630 determine a sound, projection, or action (such as vibration, opening the device in part or in full, etc.) to project, play or conduct. Note that in some embodiments, a lack of input from a sensor or timer may also trigger a sound, projection, or action. For example, if the device determines no movement, sound, or activity for a set period of time, the device may play sounds or a projection in an attempt to attract attention from a user.

At 640 the selected sounds, projections, and/or actions may be conducted. At 650 it may be determined that it is time to open the device. Appropriate or desirable sounds or projections may be determined and played, and the device may be opened at 660. In accordance with some embodiments of the present invention, once the device is opened at 660, the device may power down if and until the device is closed and reinitiated.

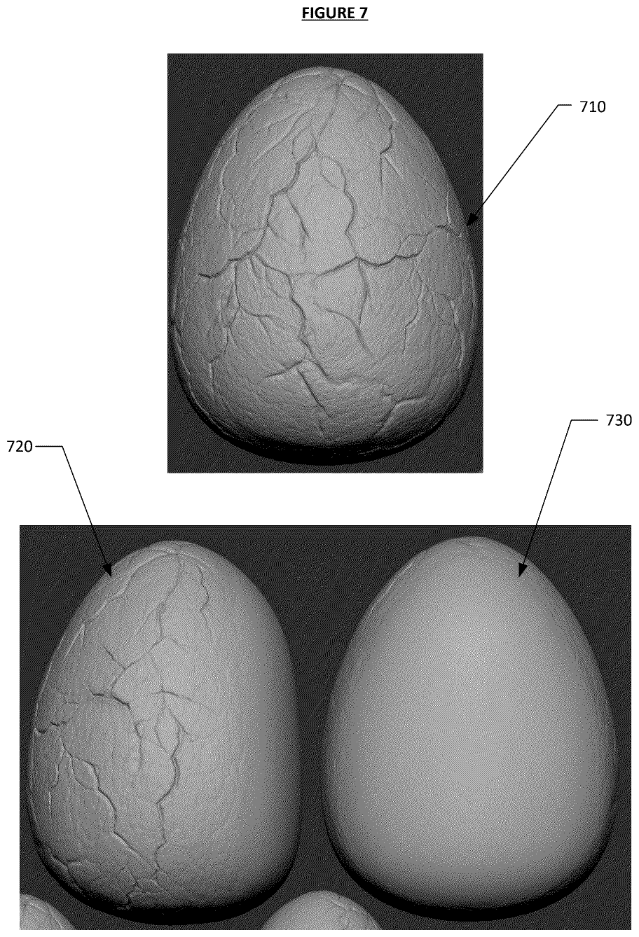

With reference to FIG. 7, an exemplary vessel that may contain various components (as discussed both above and below) will now be discussed. In general, the vessel in FIG. 7 may be an egg, with back surface 710 contoured and shaped as such. Side view 720 shows the same contouring, leading into a smooth front surface 730. Front surface 730 may be configured to receive projection, as discussed herein.

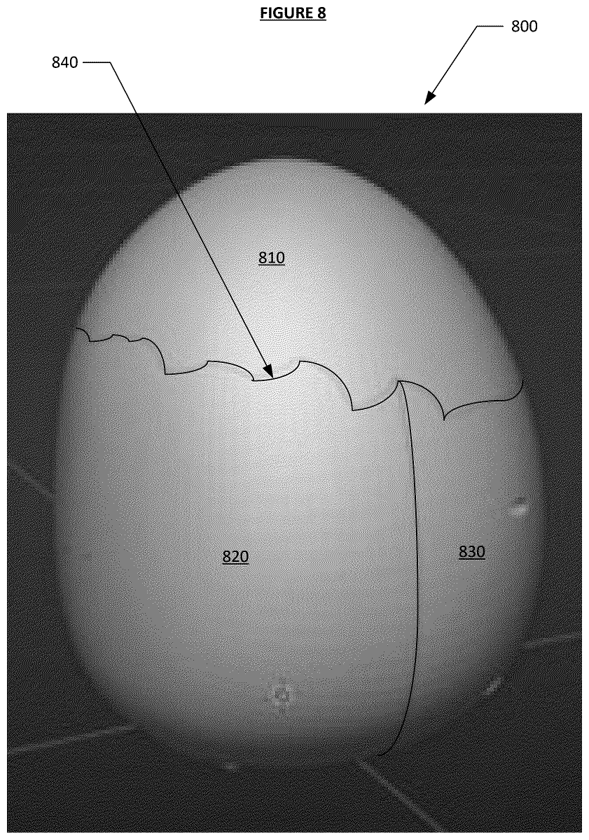

With reference to FIG. 8, a vessel 800 may, for example, be broken into three (3) components: top portion 810, front portion 820, and back portion 830. These components may be separated by cracks or joints 840.

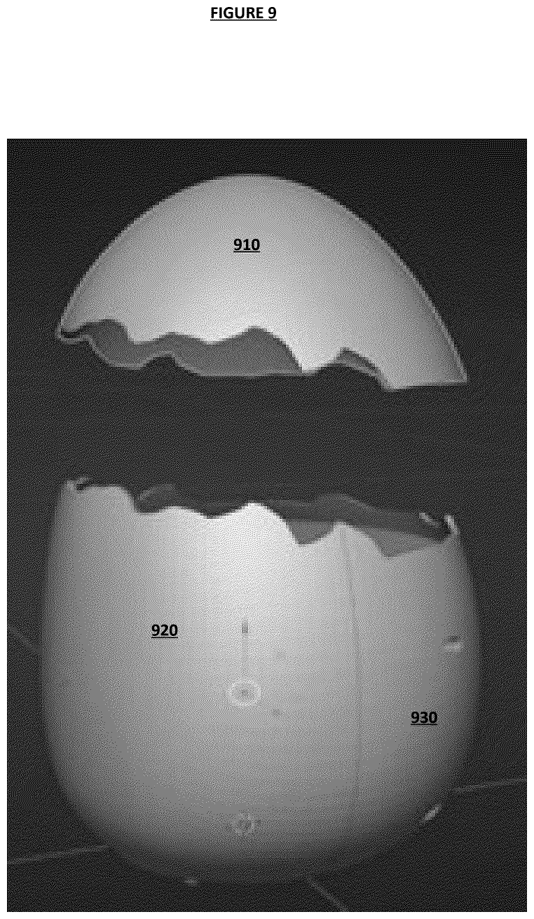

With reference to FIG. 9, a top portion 910 may be seen to be removed from front portion 920 and back portion 930.

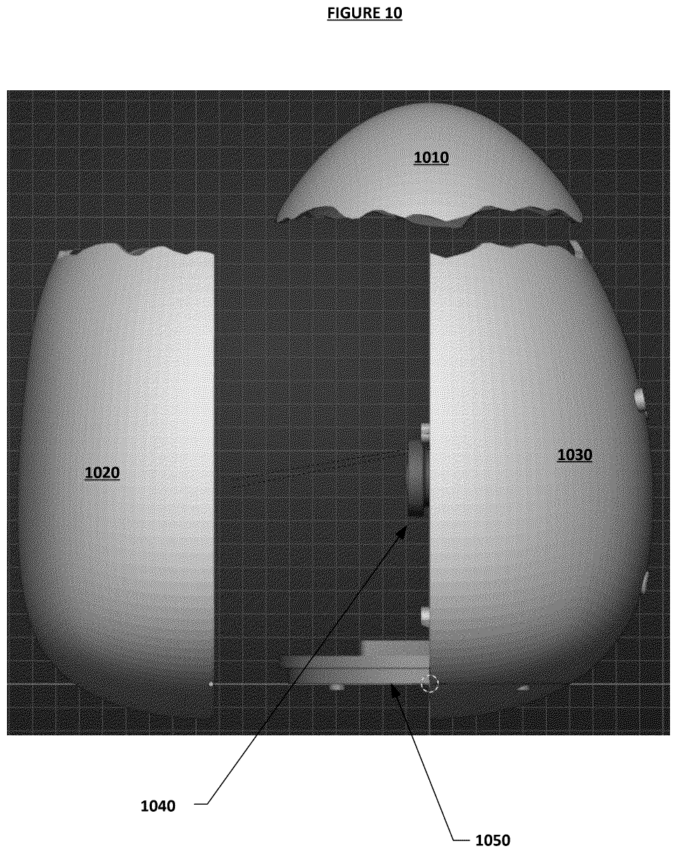

With reference to FIG. 10, both top portion 1010 and front portion 1020 may be seen to be removed. In addition, projector 1040 and bottom support platform 1050 may be seen. As discussed herein, projector 1040 may project a picture or image onto the front surface 1020. Bottom support platform 1050 may be used to attach vessel portions thereto, and to hold various other components (for example, projector(s), speaker(s), controller(s), power source(s), etc.).

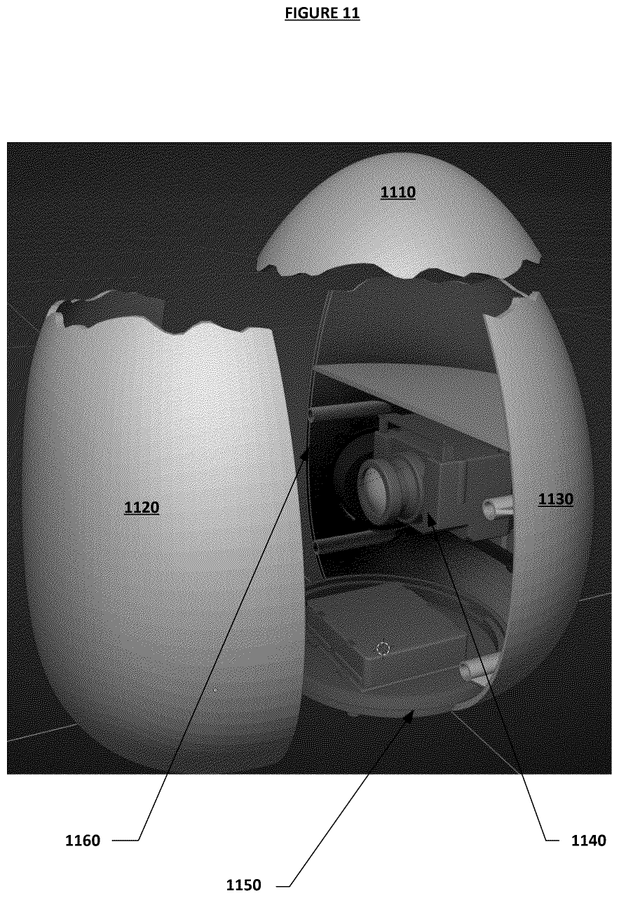

With reference to FIG. 11, a vessel may again be broken into three (3) components: top portion 1110, front portion 1120, and back portion 1130. Projector 1140 may be seen, as well as support tray 1150 (which may also hold power source, which may be, for example, one or more batteries or a component to receive plug-in power), and a speaker 1160.

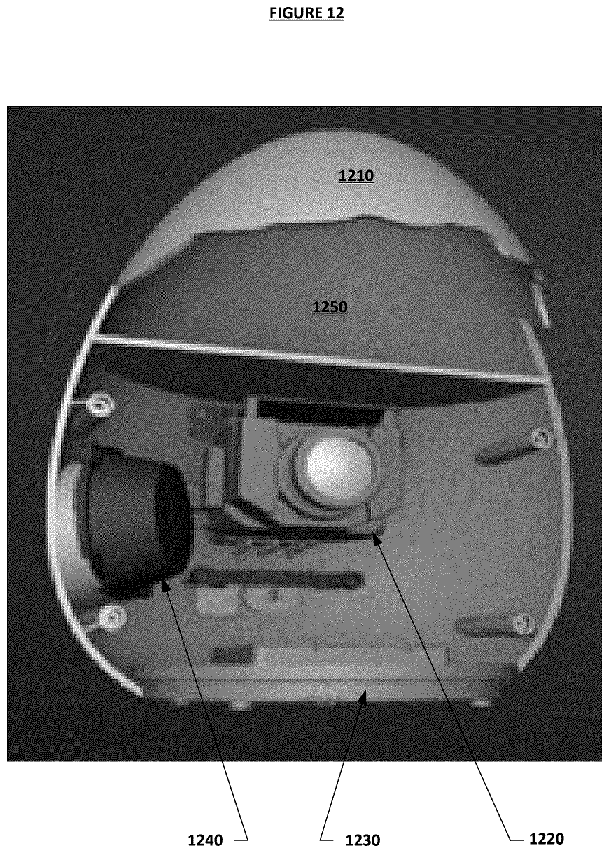

With reference to FIG. 12, inner workings of a vessel 1210 may be seen. Projector 1220 may be mounted to a back wall of vessel. Bottom support tray (which may include a power source) may be disposed at the bottom of the vessel walls, and the vessel wall(s) may be attached thereto. Speaker 1240 may be mounted in a side vessel wall, such that sound played by speaker may be projected out of the vessel.

In addition, there may be a separate area 1250 within the vessel, such that may be accessible if the top portion is removed. This separate area 1250 within the vessel may be used to store a toy or other item, which may be accessible by a user either immediately, or after a period of time—as discussed herein.

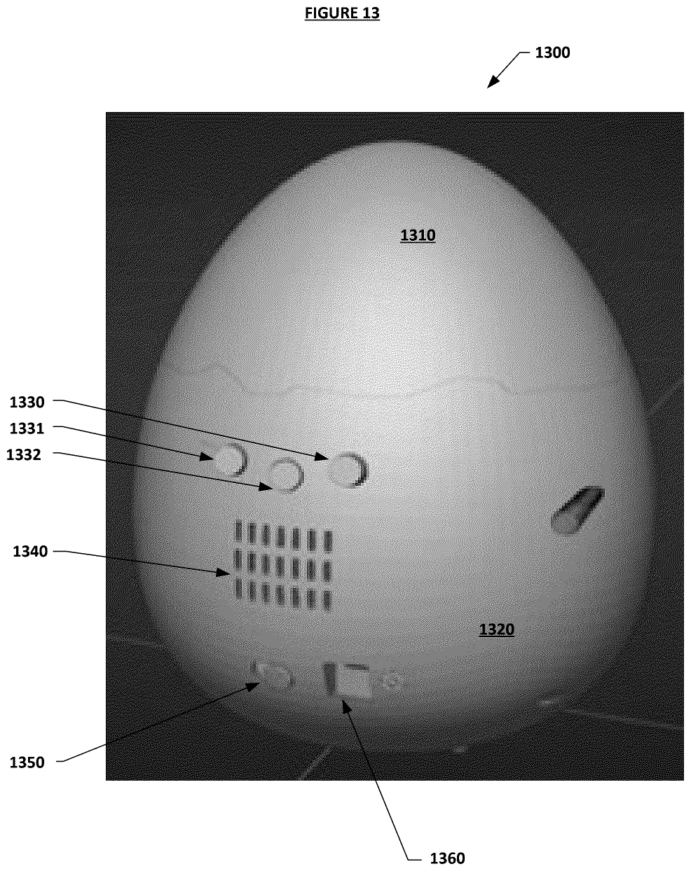

With reference to FIG. 13, a back surface of a vessel is seen, comprising a top portion 1310 and a back portion 1320. Back portion 1320 may comprise various control elements 1330, 1331, 1332, which may include but are not limited to volume, brightness, ability to skip or advance animations, play buttons, pause buttons, Bluetooth connection buttons, etc. At 1340 various apertures may be seen, which may penetrate the back portion 1320 and align with an internal speaker, such that sound emitted from the speaker may be received outside of the vessel.

Additional control components may include power or ON/OFF button 1350, and port 1360, which may be configured to receive power, network connection, and or any other sort of connection with the item.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A device comprising:
a housing, the housing enclosing:
a projector, the projector configured to project an image or animation onto at least a portion of the housing; and
a decorative item or toy.

2. The device of claim 1, further comprising an opening or unlocking mechanism for opening or unlocking at least a portion of the housing.

3. The device of claim 2, wherein the portion of the housing opened or unlocked comprises the decorative item or toy.

4. The device of claim 1, wherein the housing comprises an interior surface and an exterior surface, and wherein at least a portion of the exterior surface has a thickness and material composition selected such that, in response to projection of an image or animation onto a portion of the interior surface, the image or animation is visible on the exterior surface.

5. The device of claim 1, further comprising at least one sensor configured to detect at least one condition of the device or an environment of the device.

6. The device of claim 5, the at least one sensor comprising one or more of a proximity sensor, timer, accelerometer, light sensor, temperature sensor, pressure sensor, motion sensor, sound sensor, spring sensor, ball sensor, and/or angular velocity sensor.

7. The device of claim 6, wherein the at least one sensor is operatively connectable to the projector to activate, deactivate, and/or modify display of the animated image and/or any associated audio in response to detection of the condition.

8. The device of claim 6, wherein the at least one sensor is operatively connectable to an opening or unlocking mechanism for opening or unlocking at least a portion of the housing.

9. The device of claim 1, further comprising an audio output device configured to output an audio track, wherein the projected image or animation is projected in synchronization with the audio track.

10. The device of claim 1, further comprising a non-transitory computer-readable medium comprising computer code stored thereon, that when executed by a processor of a computing device operatively connected to the projector, controls display of the projected image or animation on the exterior surface.

11. The device of claim 1, wherein:
the housing is in the shape of an egg; and
the projected image or animation comprises a representation of a creature inside of the egg.

12. A device, comprising:
an exterior wall, wherein the entirety of the exterior wall defines a decorative shape of the device and further defines an interior surface and an exterior surface;
a projector, supported by the projector support within the cavity and contained entirely within the device, the projector configured to project a image or animation of something inside the exterior wall, when viewed from the exterior of the device; and
a decorative item or toy disposed inside the exterior wall.

13. The device of claim 12, further comprising an audio output device configured to output an audio track.

14. The device of claim 12, further comprising at least one sensor configured to detect at least one condition of the device or an environment of the device, the at least one sensor comprising one or more of a proximity sensor, timer, accelerometer, light sensor, temperature sensor, pressure sensor, motion sensor, sound sensor, spring sensor, ball sensor, and/or angular velocity sensor.

15. The device of claim 6, further comprising an opening or unlocking mechanism for opening or unlocking at least a portion of the housing; and
wherein the at least one sensor is operatively connectable to the projector and the opening or unlocking mechanism to activate, deactivate, and/or modify display of the animated image and/or any associated audio in response to detection of the condition.

16. The device of claim 15, wherein the portion of the housing opened or unlocked comprises or holds the decorative item or toy.
